(19) United States
(12) Patent Application Publication
(10) Pub. No.: US 2015/0110369 A1
(43) Pub. Date: Apr. 23, 2015

(54) IMAGE PROCESSING APPARATUS

(71) Applicant: KONINKLIJKE PHILIPS N.V., EINDHOVEN (NL)

(72) Inventors: Axel Saalbach, Hamburg (DE); Alexandra Groth, Hamburg (DE); Juergen Weese, Norderstedt (DE)

(73) Assignee: Koninklijke Philips N.V., Eindhoven (NL)

(21) Appl. No.: 14/371,305

(22) PCT Filed: Dec. 28, 2012
(86) PCT No.: PCT/IB2012/057793

§ 371 Date: Jul. 9, 2014

Related U.S. Application Data
(60) Provisional application No. 61/584,893, filed on Jan. 10, 2012.

(51) Int. Cl. G06T 7/00

(52) U.S. Cl. CPC G06T 7/0079; G06T 7/0012; G06T 2207/20112
USPC 382/128

(57) ABSTRACT

Image processing apparatus 100 comprising an input 110 for obtaining an image 102 and segmentation data 112 configured for use in segmenting a region of interest in a predetermined type of image, the input being arranged for further obtaining a segmentation data descriptor 116 of the segmentation data, the segmentation data descriptor being indicative of the predetermined type of image, and a processor 120 for (i) obtaining, based on the image, an image descriptor indicative of an actual type of the image, (ii) comparing the image descriptor to the segmentation data descriptor, and (iii) establishing, based on said comparing, a suitability indication 122 for using the segmentation data in segmenting the region of interest in the image to avoid the use of the segmentation data when the predetermined type of image insufficiently matches the actual type of the image.

### FIELD OF THE INVENTION

The invention relates to an image processing apparatus and a method of obtaining segmentation data for use in segmenting a region of interest. The invention further relates to a database and a storage medium comprising a plurality of segmentation data, a workstation and imaging apparatus comprising the image processing apparatus set forth, and a computer program product for causing a processor system to perform the method set forth.

In the fields of image evaluation and image display, an image may comprise a region that is of particular interest to a user. For example, in a medical image of a breast acquired by Magnetic Resonance Imaging (MRI), a clinician may need to inspect lesions to determine an occurrence of breast cancer. Similarly, in a cardiac image acquired by Single Photon Emission Computed Tomography (SPECT), the clinician may need to inspect the heart's left ventricle to assess of how well the heart pumps blood to the body.

It may be desirable to separate the region of interest from its surroundings, e.g., to more easily observe its shape, size or changes therein over time. For that purpose, segmentation data may be used. The segmentation data may, for example, comprise instructions for enabling an image processing apparatus to apply a segmentation technique to the region of interest. Alternatively, or additionally, the segmentation data may comprise a segmentation model for enabling a segmentation of the region of interest by automatically or semi-automatically fitting the segmentation model to the region of interest. Alternatively, or additionally, the segmentation data may comprise parameters for a segmentation technique.

### BACKGROUND OF THE INVENTION

It is known to select a model for segmenting a region of interest in an image. U.S. Pat. No. 7,796,790 B2 discloses a diagnostic imaging system. It is explained that during operation of said system, the user selects a model of an organ from an organ model database via a model selecting means. It is further explained that the selection of the model may involve dragging and dropping the organ model over a subject anatomy represented by image data while watching a superimposition of a diagnostic image and the organ model on a monitor.

A problem of the aforementioned diagnostic imaging system is that the user may easily apply a model to a particular type of image even when the model is not suitable for segmenting a region of interest in the particular type of image.

### SUMMARY OF THE INVENTION

It would be advantageous to have an apparatus or method for avoiding the use of segmentation data for segmenting a region of interest in a particular type of image when the segmentation data is not suitable for use with said type of image.

To better address this concern, a first aspect of the invention provides an image processing apparatus, comprising an input for obtaining an image and segmentation data configured for use in segmenting a region of interest in a predetermined type of image, the input being arranged for further obtaining a segmentation data descriptor of the segmentation data, the segmentation data descriptor being indicative of the predetermined type of image, and a processor for (i) obtaining, based on the image, an image descriptor indicative of an actual type of the image, (ii) comparing the image descriptor to the segmentation data descriptor, and (iii) establishing, based on said comparing, the suitability of using the segmentation data in segmenting the region of interest in the image to avoid the use of the segmentation data when the predetermined type of image insufficiently matches the actual type of the image.

In a further aspect of the invention, a workstation and an imaging apparatus are provided comprising the image processing apparatus set forth.

In a further aspect of the invention, a method is provided comprising obtaining an image and segmentation data configured for use in segmenting a region of interest in a predetermined type of image, and also obtaining a segmentation data descriptor of the segmentation data, the segmentation data descriptor being indicative of the predetermined type of image, and obtaining, based on the image, an image descriptor indicative of an actual type of the image, and comparing the image descriptor to the segmentation data descriptor, and establishing, based on said comparing, the suitability of using the segmentation data in segmenting the region of interest in the image to avoid the use of the segmentation data when the predetermined type of image insufficiently matches the actual type of the image.

In a further aspect of the invention, a computer program product comprises instructions for causing a processor system to perform the method set forth.

The input receives an image and segmentation data. The segmentation data is data which is configured for use in a segmentation of a region of interest in a predetermined type of image. The type of the image refers to a property of the image or of its content by which said type of image can be identified among a plurality of images. For example, in medical imaging, the type may relate to an image acquisition process, e.g., it may indicate whether the image is a MRI or CT image. The type is predetermined in that the segmentation data is specifically configured for use with the particular type of image. For example, the segmentation data may be specifically configured for use with MRI images. As a further example, the type may relate to a content of the image, e.g., whether the image is a cardiac image, a brain image, etc, and the segmentation data may be specifically configured for use with cardiac images, e.g., it may be a segmentation model of a heart.

The input receives a segmentation data descriptor which is indicative of the predetermined type of image. The segmentation data descriptor enables the image processing apparatus to determine for which type of image the segmentation data is configured. A processor obtains, based on the image, an image descriptor indicative of an actual type of the image. The image descriptor provides information on the type of image that is actually received by the input. The processor compares the image descriptor with the segmentation data descriptor. The image processing apparatus can therefore determine whether or not the segmentation data is configured for use with the type of image that is actually received. Accordingly, the processor establishes the suitability of using the segmentation data in segmenting the region of interest in the image. Said suitability allows the image processing apparatus, or a different apparatus, to avoid the use of the segmentation data when the segmentation data is not sufficiently suitable for use with the actual type of image.

By obtaining a segmentation data descriptor indicative of a predetermined type of image as well as an image descriptor indicative of an actual type of the image, the processor is able to determine whether the segmentation data is configured for use in segmenting a region of interest in the type of image that is actually received. The processor establishes said fact in the form of a suitability, which allows the image processing apparatus, or a different apparatus, to avoid the use of the segmentation data when the segmentation data is not sufficiently suitable for use with the actual type of image. Advantageously, errors are avoided that may otherwise be caused by the use of segmentation data that is unsuitable for use with the actual type of image. Advantageously, the user does not need to manually verify the suitability of using the segmentation data with a particular type of image.

The invention is partially based on the recognition that segmentation techniques and/or segmentation models are typically optimized for use with specific types of images. For example, in MRI, various acquisition parameters may be used, such as T1, T2, balanced, with and without fat suppression, etc. Each of said parameters yields an image having different image characteristics. As a result, the appearance of an organ in each of the images differs. In order to achieve robust and accurate segmentation for a particular type of image, the segmentation data is typically adapted to said type of image. For that purpose, learning-based techniques may be applied. Consequently, the segmentation data is not, or to a lesser degree, suitable for use with another type of image. The inventors have recognized that there is a considerable risk that such segmentation data may be applied to unsuitable types of images, e.g., a segmentation technique optimized for T1 may be applied to a T2 image.

The application of unsuitable segmentation data can lead to a degraded segmentation performance and even to complete segmentation failures. As a result, the user may need to perform manual corrections, possibly leading to lower user acceptance of the use of the segmentation data. Moreover, in a worst case scenario, the user may not notice the incorrect segmentation and may derive a wrong conclusion from the segmentation. In medical imaging, this may lead to an incorrect diagnosis and, hence, incorrect treatment.

The present invention establishes the suitability of using the segmentation data in segmenting the region of interest in the image. Consequently, use of the segmentation data can be avoided when the predetermined type of image insufficiently matches the actual type of the image, since the suitability is indicative of said insufficient degree of matching. As a result, the aforementioned degraded segmentation performance and/or the occurrence of complete segmentation failures is reduced or even avoided entirely.

In a further aspect of the invention, a database or storage medium is provided, comprising a plurality of segmentation data, each configured for use in segmenting a region of interest in a different type of image, and a plurality of segmentation data descriptors, each indicative of the different type of image for enabling establishing, based on comparing the plurality of segmentation data descriptors to an image descriptor indicative of an actual type of an image, one of said plurality of segmentation data as most suitable for segmenting the region of interest in the image.

The database and storage medium comprise, in addition to a plurality of segmentation data, also a plurality of segmentation data descriptors. Hence, an image processing apparatus can establish one of said plurality of segmentation data as most suitable for segmenting the region of interest in the image by comparing the plurality of segmentation data descriptors to an image descriptor indicative of an actual type of an image. Advantageously, the user does not need to manually verify the suitability of each one of the plurality of segmentation data for use with a particular type of image. Advantageously, the image processing apparatus can automatically determine which one of the plurality of segmentation data from the database or storage medium is most suitable for said segmenting.

Optionally, the image processing apparatus further comprises an output for warning a user when the predetermined type of image insufficiently matches the actual type of the image. The use of the segmentation data when the predetermined type of image insufficiently matches the actual type of the image is therefore avoided by warning the user. Advantageously, the user receives clear feedback that the segmentation data is not suitable for segmenting the region of interest in the type of image that is received.

Optionally, the processor, when the predetermined type of image insufficiently matches the actual type of the image, is further arranged for using the image descriptor to obtain, via the input and from a database, further segmentation data configured for use with the actual type of the image. The processor obtains further segmentation data from a database when the segmentation data that is locally available on the image processing apparatus is not suitable for segmenting a region of interest in the image. The further segmentation data is configured for use with the actual type of the image. Advantageously, a correct segmentation of the region of interest is obtained even if the segmentation data that is locally available is not suitable for segmenting the region of interest in the r type of image that is received.

Optionally, the input is arranged for obtaining a plurality of segmentation data and a respective plurality of segmentation data descriptors, and the processor is arranged for comparing the image descriptor to each of the segmentation data descriptors for establishing one of said plurality of segmentation data as most suitable for segmenting the region of interest in the image. The processor automatically establishes which one of a plurality of segmentation data is most suitable for segmenting a region of interest in the type of image that is received. Advantageously, a user does not need to manually select a most suitable one of the plurality of segmentation data. Advantageously, an optimal segmentation is obtained.

Optionally, the processor is arranged for performing an image analysis of the image for obtaining the image descriptor. The image is analyzed in order to obtain the image descriptor. Thus, the content of the image is used to obtain the image descriptor. The content of the image is highly indicative of the type of image. Advantageously, except for the image itself, no additional information is needed to obtain the image descriptor.

Optionally, performing the image analysis comprises determining an intensity histogram of the image for establishing the image descriptor being indicative of an occurrence of intensities in the image. The occurrence of intensities in an image is highly indicative of the type of image. By determining an intensity histogram of the image, the obtained occurrence of intensities enables the image descriptor to be conveniently generated.

Optionally, the segmentation data is optimized for use with a reference image, and the segmentation data descriptor is obtained by an image analysis of the reference image. Both the segmentation data descriptor and the image descriptor are obtained by an image analysis. Advantageously, the image descriptor can be easily compared to the segmentation data descriptor owing to both descriptors being obtained in a similar manner. Advantageously, the segmentation data descriptor is obtained in an automated manner.

Optionally, the image is a DICOM encoded image, the image descriptor is constituted by at least one DICOM data element of the DICOM encoded image, and the processor is arranged for using the at least one DICOM data element for establishing the actual type of the DICOM encoded image. DICOM, short for Digital Imaging and COmmunications in Medicine, is a standard for handling, storing, printing, and transmitting information in medical imaging. DICOM data elements typically provide information on the type of DICOM image. By using at least one DICOM data element for establishing the actual type of the DICOM encoded image, such information is exploited. Advantageously, the image descriptor is a reliable indicator of the actual type of the image owing to the normal reliability of the DICOM data element.

Optionally, the image descriptor is constituted by a plurality of DICOM data elements, and the processor is arranged for using the plurality of DICOM data elements in a decision tree for said establishing of the actual type of the image. Information on the type of image may be distributed over different tags, in particular, when non-standardized acquisition protocols are used. A decision tree is well suited for combining said information in order to obtain the actual type of the image. Advantageously, the image descriptor is a reliable indicator of the actual type of the image even in case a non-standardized acquisition protocol is used.

Optionally, the segmentation data descriptor and/or the image descriptor are indicative of at least one of the group of: an imaging modality, an imaging protocol, a part of a body. Said information is highly indicative of the actual or predetermined type of image.

Optionally, the method set forth further comprises, when the predetermined type of image insufficiently matches the actual type of the image, using the image descriptor to obtain further segmentation data configured for use with the actual type of the image, and obtaining license data from a license server for authorizing the use of the further segmentation data in segmenting the region of interest in the image. Further segmentation data is thus automatically obtained and licensed in case the segmentation data is not sufficiently suitable for use with the actual type of image. The further segmentation data is configured for use with the actual type of the image, and thus well suitable for said use.

Optionally, the processor is arranged for using at least one of the group of: (0008, 0060), (0018, 1030), (0018, 0015), (0020, 0037) of DICOM data elements. Said DICOM data elements comprise particular relevant information on the type of image, as DICOM data element (0008, 0060) comprises information about the used imaging modality, DICOM data element (0018, 1030) provides the name of the employed protocol, DICOM data element (0018, 0015) comprises information on a body part examined, and DICOM data element (0020, 0037) comprises an image orientation.

It will be appreciated by those skilled in the art that two or more of the above-mentioned embodiments, implementations, and/or aspects of the invention may be combined in any way deemed useful.

Modifications and variations of the workstation, imaging apparatus, database, storage medium, method, and/or computer program product, which correspond to the described modifications and variations of the image processing apparatus, can be carried out by a person skilled in the art on the basis of the present description.

A person skilled in the art will appreciate that the method may be applied to multi-dimensional image data, e.g. to two-dimensional (2-D), three-dimensional (3-D) or four-dimensional (4-D) images. A dimension of the multi-dimensional image data may relate to time. For example, a three-dimensional image may comprise a time domain series of two-dimensional images. The image may be a medical image, acquired by various acquisition modalities such as, but not limited to, standard X-ray Imaging, Computed Tomography (CT), Magnetic Resonance Imaging (MRI), Ultrasound (US), Positron Emission Tomography (PET), Single Photon Emission Computed Tomography (SPECT), and Nuclear Medicine (NM).

The invention is defined in the independent claims. Advantageous embodiments are defined in the dependent claims.

### BRIEF DESCRIPTION OF THE DRAWINGS

These and other aspects of the invention are apparent from and will be elucidated with reference to the embodiments described hereinafter. In the drawings,

FIG. 1 shows an image processing apparatus according to the present invention, said apparatus comprising an input and a processor;

FIG. 2 shows a method according to the present invention;

FIG. 3 shows a computer program product according to the present invention;

FIG. 4 shows a database comprising a plurality of segmentation data;

FIG. 5 shows an image processing apparatus obtaining, via an input, further segmentation data from a database; and

FIG. 6 shows the image processing apparatus displaying a warning on a display when the user selects unsuitable segmentation data.

### DETAILED DESCRIPTION OF EMBODIMENTS

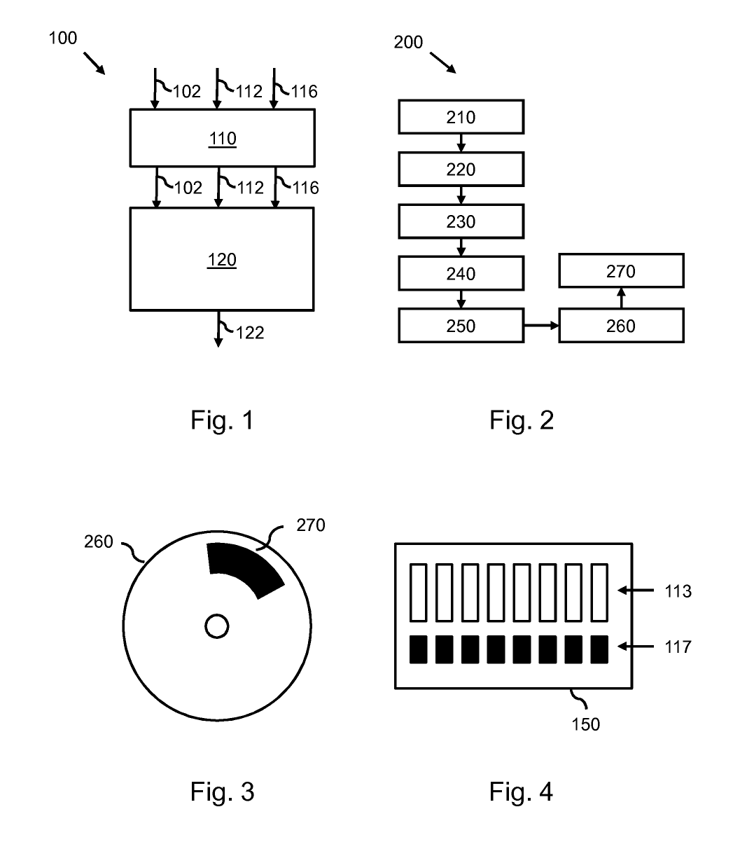

FIG. 1 shows an image processing apparatus 100, henceforth referred to as apparatus 100. The apparatus 100 comprises an input 110 for obtaining an image 102 and segmentation data 112. The segmentation data 112 is configured for use in segmenting a region of interest in a predetermined type of image. The input 110 is arranged for further obtaining a segmentation data descriptor 116. The segmentation data descriptor 116 is indicative of the predetermined type of image. The apparatus 100 further comprises a processor 120 for (i) obtaining, based on the image 102, an image descriptor indicative of an actual type of the image 102, (ii) comparing the image descriptor to the segmentation data descriptor 116, and (iii) establishing, based on said comparing, the suitability 122 of using the segmentation data 112 in segmenting the region of interest in the image 102.

The operation of the apparatus 100 may be explained using an example of the use of the apparatus 100 in the field of medical image analysis. In this field, image segmentation plays an increasingly important role, and in particular model-based segmentation, which has turned out to be a powerful paradigm that may be applied in a broad range of applications, e.g., from intervention planning in the context of RF ablation or aortic valve treatment to Alzheimer diagnosis. In order to achieve a robust and accurate segmentation, segmentation models are typically optimized for specific imaging modalities and protocols. For that purpose, a so-termed “Simulated Search” may be used, in which the typical appearance of an organ in an image is learned, e.g., in terms of image intensities, and employed for segmentation purposes. However, there is a considerable risk that a segmentation model is applied on unsuitable images and that as a result, unsatisfying or erroneous results are obtained. This holds especially for MRI due to its large number of acquisition parameters, e.g., T1, T2, balanced, with and without fat suppression, etc.

By means of the apparatus 100, incorrect use of the aforementioned model-based segmentation can be avoided. In general, the segmentation data descriptor 116 constitutes data that indicates for which type of image the segmentation data 112, e.g., data of the aforementioned model-based segmentation, is configured. The segmentation data descriptor 116 is thereby associated with the segmentation data 112. The segmentation data descriptor 116 may be obtained by the apparatus 100 in various ways. For example, the segmentation data descriptor 116 may already be part of the segmentation data 112. For example, metadata or header information of the segmentation data 112 may be specifically indicative of the predetermined type of image. The segmentation data descriptor 116 may also be specifically included in the segmentation data 112. Also, the segmentation data descriptor 116 may constitute separate data, e.g., a file. In general, the segmentation data descriptor 116 may be manually generated, e.g., by manually specifying the predetermined type of image in order to generate the segmentation data descriptor 116. Alternatively, the segmentation data descriptor 116 may be automatically generated, e.g., during a learning process where the segmentation data 112 is learned from a reference image.

The apparatus 100 obtains, based on the image 102, an image descriptor indicative of an actual type of the image. The image descriptor may be obtained by the apparatus 100 in various ways. For example, the image 102 may be a DICOM encoded image, and the processor 120 may be arranged for obtaining the image descriptor in the form of at least one DICOM data element of the DICOM encoded image. Moreover, the processor 120 may be arranged for using the at least one DICOM data element for establishing the actual type of the DICOM encoded image. In particular, the processor 120 may be arranged for using at least one of the group of: (0008, 0060), (0018, 1030), (0018, 0015), (0020, 0037) of DICOM data elements. The aforementioned DICOM data elements can provide additional information about the image acquisition, and hence, indicate the actual type of the image 102. The DICOM data element (0008,0060) provides information about the used imaging modality, e.g. CT, MR. The DICOM data element (0018,1030) provides the name of the employed protocol. The actual type of the image 102 may relate to an orientation of the patient within the image. This information may be obtained from the DICOM data elements (0018,1030) ImagePositionPatient and (0020,0037) ImageOrientationPatient. Moreover, for obtaining information on whether a region of interest is within the image 102, the DICOM /data element (0018,0015) BodyPartExamined can be used. Said information may also be used for an improved initialization of the segmentation.

When specific aquisitions, such as the aforementioned T1, T2, etc., are used, the actual type of the image 102 may be directly derived from the aforementioned DICOM data elements. Otherwise, information about the actual type of the image 102 may be scattered over many different DICOM data elements such as (0018,0023) and (0018,0087). In order to derive the actual type of the image 102 from such scattered information, the processor 120 may be arranged for using a plurality of DICOM data elements in a decision tree for establishing the actual type of the image 102. Decision trees are known per se from the field of decision analysis and the more general field of probability mathematics. As a result, the actual type of the image 102 may be established by evaluating the decision tree using the DICOM data elements, with contents of said DICOM data elements determining which branch is followed within the decision tree.

Alternatively or additionally to using DICOM data elements for obtaining the image descriptor indicative of the actual type of the image 102, the processor 120 may be arranged for performing an image analysis of the image 102 for obtaining the image descriptor. Therefore, the image content is analyzed in order to obtain information that is indicative of the actual type of the image 102. Performing the image analysis may comprise determining an intensity histogram of the image 102 for establishing the image descriptor being indicative of an occurrence of intensities in the image 102. It is noted that the occurrence of image intensities varies depending on the used acquisition protocols and/or parameters, e.g., for MRI acquisitions, depending on whether the acquisition protocol is T1, T2, balanced, etc. Also, the administration of a contrast agent and the timing of the image acquisition with respect to said administration affect the occurrence of image intensities within the image 102.

The image descriptor may thus be obtained from an image analysis, for example, from an intensity histogram of the image 102. In particular, the image descriptor may comprise, or be based on, minimum intensity values, maximum intensity values and the intensity histogram itself To facilitate comparing the image descriptor to the segmentation data descriptor 116, the segmentation data descriptor 116 may also be obtained from an intensity histogram. However, instead of being obtained from the image 102, said intensity histogram image may be obtained from training image data which was used for generating the segmentation data 112. For example, when the training image data is a reference image, resulting in the segmentation data 112 being optimized for use with the reference image, the segmentation data descriptor 116 may be obtained by an image analysis of the reference image, and in particular, by determining an intensity histogram of the reference image.

In the above, comparing the image descriptor to the segmentation data descriptor 116 may comprise comparing the image histogram derived from the image 102 to a representative set of image histograms during the segmentation data's 112 development. The comparing may involve using histogram intersection techniques or the earth mover's distance, i.e., the so-termed Mallows distance. It is noted that such techniques are known per se from the field of image analysis. Alternatively or additionally to determining an intensity histogram, performing the image analysis may comprise, e.g., taking organ variability such as pulmonary vein variants into account. For example, around 70% of all patients have 4 pulmonary veins, yet patients with 3 or 5 pulmonary veins also exist. Hence, the image descriptor may be indicative of the number of pulmonary veins in the image 102, and the segmentation data descriptor 116 may be indicative of the number of pulmonary veins for which the segmentation data 112 has been optimized or specifically configured.

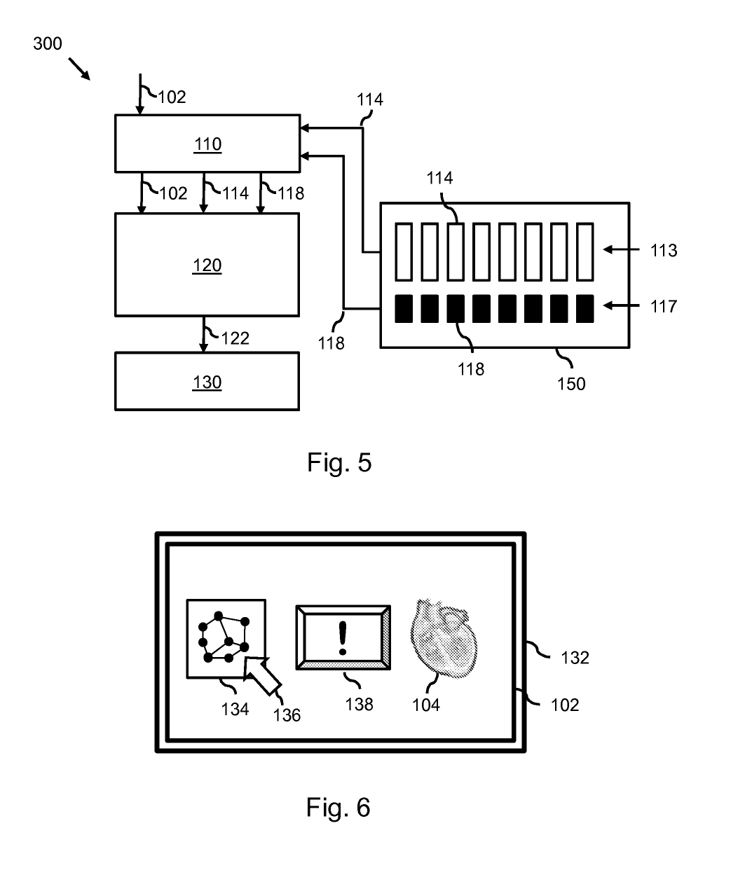

As a result of comparing the image descriptor to the segmentation data descriptor 116, the suitability 122 of using the segmentation data 112 in segmenting the region of interest in the image 102 is obtained. The suitability 122 may be used to avoid the use of the segmentation data 112 when the predetermined type of image insufficiently matches the actual type of the image 102. For example, in case the apparatus 100 is also arranged for performing the segmentation of the region of interest in the image 102, the apparatus 100 may determine not to segment the region of interest in the image 102 using the segmentation data 112. The user may be alerted to said fact, e.g., by an audio and/or video signal. The apparatus 100 may also be arranged for merely warning the user using said audio and/or video signal. Therefore, the user may nevertheless choose to use the segmentation data 112 for segmenting the region of interest in the image 102. Alternatively or additionally, the apparatus 100 may be arranged for, instead of using the segmentation data 112, obtaining further segmentation data 114 which is more suitable for segmenting the region of interest in the image 102. These aspects will be discussed in reference to FIGS. 5 and 6. The suitability 122 may be established in the form of suitability data. The suitability data may comprise a value. A high value may indicate a high suitability and a low value a low suitability. The value may also be a binary value, indicating whether or not the segmentation data 112 is suitable for use in segmenting the region of interest in the image 102. It is noted that the suitability 122 may also be established in the form of a signal or any other suitable form.

It will be appreciated that the apparatus 100 itself may not need to be arranged for performing the segmentation of the region of interest in the image 102. Rather, the apparatus may act as an intermediary between the segmentation data 112 and a further apparatus which uses the segmentation data 112 in segmenting the region of interest in the image 102. The suitability 122 may be provided to the further apparatus. Alternatively or additionally, the suitability 122 may affect which segmentation data 112 the apparatus 100 provides to the further apparatus, or whether said data is provided at all.

FIG. 2 shows a method 200 comprising, in a first step titled “OBTAINING IMAGE AND SEGMENTATION DATA”, obtaining 210 an image and segmentation data configured for use in segmenting a region of interest in a predetermined type of image. The method 200 further comprises, in a second step titled “OBTAINING SEGMENTATION DATA DESCRIPTOR”, obtaining 220 a segmentation data descriptor indicative of the predetermined type of image. The method 200 further comprises, in a third step titled “OBTAINING IMAGE DESCRIPTOR”, obtaining 230, based on the image, an image descriptor indicative of an actual type of the image. The method 200 further comprises, in a fourth step titled “COMPARING IMAGE DESCRIPTOR TO SEGMENTATION DATA DESCRIPTOR”, comparing 240 the image descriptor to the segmentation data descriptor. The method 200 further comprises, in a fifth step titled “ESTABLISHING SUITABILITY”, establishing 250, based on said comparing, the suitability of using the segmentation data in segmenting the region of interest in the image to avoid the use of the segmentation data when the predetermined type of image insufficiently matches the actual type of the image.

The method 200 may further comprise, when the predetermined type of image insufficiently matches the actual type of the image, a sixth step titled “OBTAINING FURTHER SEGMENTATION DATA”, comprising using 260 the image descriptor to obtain further segmentation data configured for use with the actual type of the image, and a seventh step titled “OBTAINING LICENSE DATA”, comprising obtaining 270 license data from a license server for authorizing the use of the further segmentation data in segmenting the region of interest in the image. It is noted that the further segmentation data may be obtained 260 from the license server. Moreover, the method 200 may comprise obtaining 270 the license data from the license server before obtaining the further segmentation data.

The method 200 may correspond to an operation of the apparatus 100, and is discussed throughout with reference to said operation of the apparatus 100. It is noted, however, that the method 200 may also be performed in separation from said apparatus 100.

FIG. 3 shows a computer program product 270 comprising instructions for causing a processor system to perform the method according to the present invention. The computer program product 270 may be comprised in a computer readable medium 260, for example in the form of a series of machine readable physical marks and/or as a series of elements having different electrical, e.g., magnetic, or optical properties or values.

FIG. 4 shows a database 150 comprising a plurality of segmentation data 113, each being configured for use in segmenting a region of interest in a different type of image. For illustration purposes, each of the plurality of segmentation data 113 is shown in FIG. 4 as a white rectangle. For example, a first one of the plurality of segmentation data 113 may be configured for segmenting a heart in a cardiac image, and a second one of the plurality of segmentation data 113 may be configured for segmenting a brain in a brain image. As another example, a first one of the plurality of segmentation data 113 may be configured for segmenting a region of interest in a T1 MRI image, and a second one of the plurality of segmentation data 113 may be configured for segmenting the region of interest in a T2 MRI image. The database 150 further comprises a respective plurality of segmentation data descriptors 117, each being indicative of the different type of image. The plurality of segmentation data descriptors 117 enable establishing one of said plurality of segmentation data as most suitable for segmenting the region of interest in the image by means of comparing the plurality of segmentation data descriptors 117 to an image descriptor indicative of an actual type of an image. For illustration purposes, each of the plurality of segmentation data descriptors 117 is shown in FIG. 4 as a black rectangle, and each of the plurality of segmentation data descriptors 117 is shown to be horizontally co-located with the respective one of the plurality of segmentation data 113 of which it is indicative.

FIG. 5 shows an image processing apparatus 300, henceforth referred to as apparatus 300, comprising the processor 120 which, when the predetermined type of image insufficiently matches the actual type of the image 102, is further arranged for using the image descriptor to obtain, via the input 110 and from the database 150, further segmentation data 114 configured for use with the actual type of the image 102. For obtaining the further segmentation data 114, the input 110 is shown to be connected to the database 150. The processor 120 may be arranged for obtaining the further segmentation data 114 by providing the image descriptor to the database 150, with the database 150, in response, providing the further segmentation data 114. The database 150 may additionally provide a further segmentation data descriptor 118. The processor 120 may thus verify that the further segmentation data 114 is configured for use with the actual type of the image 102.

It is noted that the previously mentioned decision tree may be employed for the identification of the further segmentation data. Hence, the decision tree may not only be employed for obtaining the image descriptor, but may at the same time also provide an indication of which further segmentation data 114 is configured for segmenting the region of interest in the actual type of the image 102. This information may be used for obtaining the further segmentation data 114 by requesting said data from the database 150.

It is noted that by using the image descriptor to obtain further segmentation data 114 configured for use with the actual type of the image 102, the apparatus 300 may be conveniently extended with new or improved segmentation data. As a result, a higher segmentation success rate and quality may be obtained. In general, the present invention may provide an extendable image segmentation framework which allows for automatic verification, selection and installation of further segmentation data 114.

In such an extendable image segmentation framework, the outcome of the verification step, i.e., the suitability 122, may be used to, e.g., select and/or recommend further segmentation data 114 that is already included in the apparatus 300. In this respect, it is noted that the database 150 may be an internal database, i.e., may be part of the apparatus 300. The suitability 122 may also be used to suggest the installation of further segmentation data 114 from a remote source, or to obtain a license of already installed further segmentation data 114. In this respect, it is noted that the database 150 may be an external database, i.e., located outside of the apparatus 300. The database 150 may be a remote database.

As an example of the aforementioned extendable image segmentation framework, RF ablation of the left atrium may be considered where pre-procedural MRI images are segmented and used as an overlay for inter-procedural fluoroscopy images. In such an application, the apparatus 300 may allow for the use of further segmentation data. When an image 102 is subject to processing, the apparatus 300 may check the suitability of the segmentation data available on the apparatus 300. When no suitable segmentation data is available, installation of further segmentation data 114 from a remote database 150, or the licensing of already existing segmentation data on the apparatus 300, may be proposed. Alternatively or additionally to the input 110 obtaining further segmentation data 114, the input 110 may be arranged for obtaining a plurality of segmentation data 113 and a respective plurality of segmentation data descriptors 117. For that purpose, the input 110 may be connected to the database 150, as shown in FIG. 5, with the database 150 comprising said data and descriptors. The processor 120 may be arranged for comparing the image descriptor to each of the segmentation data descriptors 117 for establishing one of said plurality of segmentation data 113 as most suitable for segmenting the region of interest in the image 102. The processor 120 may thus compare the image descriptor to each of the segmentation data descriptors 117, determine which of the segmentation data descriptors 117 is most similar to the image descriptor, and then select the corresponding one of the plurality of segmentation data 113. Therefore, the apparatus 300 may automatically select one of the plurality of segmentation data 113 that is most suitable for segmenting the region of interest.

The apparatus 300 is shown to further comprise an output 130 for warning a user when the predetermined type of image insufficiently matches the actual type of the image 102. The output 130 may be arranged for generating an audio signal for warning the user. The output 130 may be a speaker. The output 130 may also be arranged for visually warning the user. The output 130 may be, e.g., a display 132 for showing a graphical warning to the user. FIG. 6 shows the display 132. The display 132 shows the image 102 comprising a region of interest 104, and, overlaid on top of the image 102, a graphical representation 134 of segmentation data. The user may select the segmentation data by clicking with a cursor 136 on the graphical representation 134 of the segmentation data. The selection may denote a desire of the user to use the segmentation data in segmenting the region of interest 104 in the image 102. In response to the selection, the apparatus 300 may compare the image descriptor of the image 102 to the segmentation data descriptor of the segmentation data. If the segmentation data is determined to be insufficiently suitable for segmenting the region of interest 104 in the image 102, the apparatus 300 may generate, based on the suitability, a warning 138 that is displayed on the display 132. By warning the user, the use of the insufficiently suitable segmentation data is typically avoided.

Although not shown in FIG. 5, the apparatus 110 may further comprise a user input for obtaining selection data from the user. For that purpose, the user input may be connected to a user interface means such as a mouse, keyboard, touch screen, etc, for receiving user interface commands, such as clicking, from the user via the user interface means. Consequently, the selection data may be indicative of the clicking with the cursor by the user. Moreover, it is noted that the display 132 may be an external display, i.e., it does not form part of the apparatus 300. Alternatively, the display 132 may be part of the apparatus 300. The apparatus 300 and the display 132 may together form a system 100.

It will be appreciated that the invention also applies to computer programs, particularly computer programs on or in a carrier, adapted to put the invention into practice. The program may be in the form of a source code, an object code, a code intermediate source and object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or to be used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. Image processing apparatus comprising:
an input for obtaining an image and segmentation data configured for use in segmenting a region of interest in a predetermined type of image;
the input being arranged for further obtaining a segmentation data descriptor of the segmentation data, the segmentation data descriptor being indicative of the predetermined type of image; and
a processor for (i) obtaining, based on the image, an image descriptor indicative of the actual type of the image, (ii) comparing the image descriptor to the segmentation data descriptor, and (iii) establishing, based on said comparing, the suitability of using the segmentation data in segmenting the region of interest in the image to avoid the use of the segmentation data when the predetermined type of image insufficiently matches the actual type of the image.

2. Image processing apparatus according to claim 1, further comprising an output for warning a user when the predetermined type of image insufficiently matches the actual type of the image.

3. Image processing apparatus according to claim 1, wherein, the processor, when the predetermined type of image insufficiently matches the actual type of the image, is further arranged for using the image descriptor to obtain, via the input and from a database further segmentation data configured for use with the actual type of the image.

4. Image processing apparatus according to claim 1, wherein the input is arranged for obtaining a plurality of segmentation data and a respective plurality of segmentation data descriptors, and the processor is arranged for comparing the image descriptor to each of the segmentation data descriptors for establishing one of said plurality of segmentation data as most suitable for segmenting the region of interest in the image.

5. Image processing apparatus according to claim 1, wherein the processor is arranged for performing an image analysis of the image for obtaining the image descriptor.

6. Image processing apparatus according to claim 5, wherein performing the image analysis comprises determining an intensity histogram of the image for establishing the image descriptor being indicative of an occurrence of intensities in the image.

7. Image processing apparatus according to claim 5, wherein the segmentation data is optimized for use with a reference image, and the segmentation data descriptor is obtained by an image analysis of the reference image.

8. Image processing apparatus according to claim 1, wherein the image is a DICOM encoded image, the image descriptor is constituted by at least one DICOM data element of the DICOM encoded image, and the processor is arranged for using the at least one DICOM data element for establishing the actual type of the DICOM encoded image.

9. Image processing apparatus according to claim 8, wherein the image descriptor is constituted by a plurality of DICOM data elements, and the processor arranged for using the plurality of DICOM data elements in a decision tree for said establishing the actual type of the image.

10. Image processing apparatus according to claim 1, wherein the segmentation data descriptor and/or the image descriptor is indicative of at least one of the group of: an imaging modality, an imaging protocol, a part of a body.

11. Workstation or imaging apparatus comprising the image processing apparatus of claim 1.

12. Database or storage medium comprising:
a plurality of segmentation data, each configured for use in segmenting a region of interest in a different type of image; and
a plurality of segmentation data descriptors, each indicative of the different type of image for enabling establishing, based on comparing the plurality of segmentation data descriptors to an image descriptor indicative of the actual type of an image, one of said plurality of segmentation data as most suitable for segmenting the region of interest in the image.

13. Method omprising:
obtaining an image and segmentation data configured for use in segmenting a region of interest in a predetermined type of image;
further obtaining a segmentation data descriptor of the segmentation data, the segmentation data descriptor being indicative of the predetermined type of image;
obtaining, based on the image, an image descriptor indicative of the actual type of the image;
comparing the image descriptor to the segmentation data descriptor; and
establishing, based on said comparing, the suitability of using the segmentation data in segmenting the region of interest in the image to avoid the use of the segmentation data when the predetermined type of image insufficiently matches the actual type of the image.

14. Method according to claim 13, further comprising, when the predetermined type of image insufficiently matches the actual type of the image:
using the image descriptor to obtain further segmentation data configured for use with the actual type of the image; and
obtaining license data from a license server for authorizing the use of the further segmentation data in segmenting the region of interest in the image.

15. A computer program product comprising instructions for causing a processor system to perform the method according to claim 14.
